(19) United States
(12) Patent Application Publication
(10) Pub. No.: US 2011/0028154 A1
(43) Pub. Date: Feb. 3, 2011

(54) METHOD FOR MULTIHIERARCHICAL ADDRESSING OF CELLS IN A CELLULAR COMMUNICATION NETWORK

(76) Inventors: Axel Klatt, Koeln (DE); Karl-Heinz Nenner, Bornheim (DE); Rifat Can, Bonn (DE)

Correspondence Address: KF ROSS PC, 5683 RIVERDALE AVENUE, SUITE 203 BOX 900, BRONX, NY, 10471-0900, US

(21) Appl. No.: 12/866,605

(22) PCT Filed: Jul. 21, 2009
(86) PCT No.: PCT/EP09/05300

§ 371 Date: Sep. 29, 2010

(30) Foreign Application Priority Data
Jul. 29, 2008 (DE) 10 2008 035 393.0

(51) Int. Cl. H04W 74/00

(52) U.S. Cl. 455/450

(57) ABSTRACT

A method for operating a cellular mobile telephone network formed by a multiplicity of cells, with several cells at a time being grouped into a location area, by means of which mobile telephone terminals attached to the mobile telephone network can be located and addressed in this location area such that, for the purpose of establishing a call with a mobile telephone terminal, all cells in this location area page the mobile telephone terminal, wherein several groups (1, 2, 3 N) of location areas are created, with each cell being assigned to one or more of said groups (1, 2, 3, . . . N) and a cell being assignable to different of said groups (1, 2, 3, . . . N), and addressing of the cell being performed according to its affinity to a specific group (1, 2, 3, . . . N) of said groups.

The invention relates to a method for operating a cellular mobile telephone network formed by a multiplicity of cells, with several cells at a time being grouped into a location area, by means of which mobile telephone terminals attached to the mobile telephone network can be located and addressed in this location area such that, for the purpose of establishing a call with a mobile telephone terminal, all cells in this location area page the mobile telephone terminal.

In today's cellular mobile telephone networks, for example those compliant with the GSM, UMTS or EPS standard [www.3gpp.org], the state of the art is to group geographically connected cells into location areas/routing areas/tracking areas (hereinafter, the term “location areas” includes routing areas and tracking areas) that are used for paging a mobile telephone terminal via the mobile telephone system. In this respect, paging is always carried out in all cells belonging to a location area. When changing from one location area to another, the mobile telephone terminal executes a location area update procedure. For the purpose of establishing a call (mobile terminated call), the mobile telephone terminal is paged in the current location area by the mobile telephone system, i.e. such paging is performed when a connection is to be established with the mobile telephone terminal.

A disadvantage of the known methods is that this approach of grouping cells according to their geographical proximity is a very rigid and inflexible one which results in a very high signaling load, especially through paging procedures. Also, this kind of location areas does not permit the consideration of further criteria of cell properties. A further disadvantage is that the assignment of a cell to a specific location area is static and the cell can only be assigned to one single group.

The object of the invention is to develop a method of the kind stated at the beginning such that it will overcome the mentioned disadvantages and allow a greater degree of flexibility and reduce the signaling load within the mobile telephone network.

In accordance with the invention, this object is achieved by the method set forth in claim 1. Advantageous developments of the invention are given in the dependent claims.

In the method according to the invention for operating a cellular mobile telephone network formed by a multiplicity of cells, with several cells at a time being grouped into a location area, by means of which mobile telephone terminals attached to the mobile telephone network can be located and addressed in this location area such that, for the purpose of establishing a call with a mobile telephone terminal, all cells in this location area page the mobile telephone terminal, it is especially advantageous that several groups of location areas are created, with each cell being assigned to one or more groups and a cell being assignable to different groups, and addressing of the cell being performed according to its affinity to a specific group.

The method according to the invention proposes in particular a multi-hierarchical addressing of cells of a mobile telephone system or groups of cells of a cellular mobile telephone system for the purpose of optimizing the signaling load. As a major improvement on the prior art, the method according to the invention permits the grouping of cells of a cellular mobile telephone system according to non-geographical criteria while at the same time increasing the efficiency of addressing and signaling. An advantageous embodiment is the use of multi-hierarchical addressing when using a large number of small mobile telephone cells (femtocells/Home NB/Home eNB/CSG cells).

Preferably, the groups are formed according to definable criteria, in particular according to which cells form a geographically connected and/or geographically delimited area and/or a group of cells for a closed subscriber group and/or a logically connected group of cells.

This allows a variety of criteria to be considered for the useful formation of groups.

Preferably, the location areas of different groups overlap spatially, the groups being ordered hierarchically and addressing taking place according to the hierarchical level.

Since several location areas of different groups can overlap, a cell can be assigned to different groups at the same time, clear addressing of the cell being assured because the addressing is done in accordance with the hierarchical level. The possibility of superimposing several location areas enables a greater degree of flexibility in operating the cellular mobile telephone network than is the case with the rigid assignment according to the prior art.

Preferably, several hierarchical levels of groups are established, with each hierarchical level comprising a plurality of groups.

Preferably, a group comprises a plurality of subgroups.

Preferably, each cell has an address for each affinity to a group, the address being formed of several segments which identify the affinity of the cell to a specific hierarchical level and/or to a specific group and/or to a specific location area.

Through the invention, therefore, cells in a cellular communication network are addressed via a multi-hierarchical system. As an advantageous development, the method according to the invention makes it possible through the hierarchical addressing to contact mobile telephone subscribers in a geographically selective way with better utilization of resources in comparison with methods according to the prior art.

Especially advantageous is that the method allows multi-dimensional hierarchical addressing. This multi-dimensional addressing enables grouping of cells according to their different properties such as the type of cell and/or the affinity to a specific group and/or the geographical proximity of the cells to each other.

It is especially advantageous that different dimensions can be considered by different processes in order to allow the efficiency of these processes in a mobile telephone system to be improved at the same time. For example, for paging a mobile telephone terminal in cellular mobile telephone networks, the geographical position of the cells used for paging is an important criterion. Typically, the cells are grouped into location areas/routing areas/tracking areas according to their geographical proximity to one another, thus optimizing both the mobility management update procedures and the paging procedures.

Instead of tracking the local position of mobile telephone terminals in idle mode according to individual cells, the mobile telephone network can do this according to specific geographical areas only, in order to thus optimize the location update signaling and also the paging traffic in the mobile telephone system. This method is the current state of the art and is used in all of today's cellular mobile telephone systems (for GSM, see [3GPP TS 04.08] or [3GPP TS 03.60]; for UMTS [3GPP TS 24.008] or [3GPP TS 23.0609]).

In these references, methods are also described which allow for individual mobile telephone terminals to be denied access to a location area/routing area/tracking area by means of a “location/routing/tracking area update reject” signal. The steps to be executed by the mobile telephone network following the rejection (such as the blocking of all cells in a location area) are also described in these documents and are used today in cellular mobile telephone networks in some cases for geographically selective blocking of partial areas of the mobile telephone network.

For other applications, however, it can also be useful to address cells according to affinity criteria other than geographical affinity. For example, the decision to allow terminals access to cells can be made according to a logical, but not geographical grouping of the cells.

In this respect, the addressing need not consider any geographical affinity but must consider the logical affinity of the cells.

In this connection, a grouping and addressing of cells through multiple hierarchical levels makes it possible, at the same time, to increase the efficiency and flexibility of various functions in a cellular mobile telephone system.

The benefits and possible applications of having different levels for addressing is explained in more detail in the following exemplary embodiments.

### Scenario 1

In cellular mobile telephone networks—for example those complying with the GSM or UMTS standard—when in the idle mode, the position of mobile telephone terminals is only known to the mobile telephone network on the location area level. The location area is an area formed by grouping together several cells of the cellular mobile telephone network. If a mobile telephone terminal is attached to the mobile telephone network, the actual position of the mobile telephone terminal within a is particular cell of the network is not always known at all times; merely the presence of the mobile telephone terminal within such a location area is known.

As a consequence, paging of a mobile telephone terminal in order to establish a call with this mobile telephone terminal is carried out in all cells belonging to this location area. A location area consists of cells which are normally positioned close to one another geographically and constitute a geographically connected area and/or serve a closed geographical region. A mobile telephone terminal performs a location area update procedure whenever the location area of the current cell has changed. This is notified to the mobile telephone terminal by the emission of a location area identity, i.e. by transmitting the identifier of the location area. As long as the mobile telephone network knows the exact position of the cells, this grouping is relatively simple. However, if, for example, a home access point is used, given that the access point can be put into operation at any desired geographical location, it is not possible to assign these cells by location, i.e. geographical position, only. It must therefore also be possible to address these home cells (home access points) individually during paging.

Such a home access point is, so to speak, a private extension of the existing mobile telephone network, the use of which is, however, restricted to the owner of the home access point, i.e. it does not become part of the public mobile telephone network for public use.

### Scenario 2

In this scenario, a building is covered by several home cells. These home cells are only accessible to a closed subscriber group (CSG) and are therefore also referred to as CSG cells. A mobile telephone terminal located within this building is to be paged (i.e. be reachable) in all of these cells. In this case, the cell type (CSG cell), the logical grouping (CSG) and the location must be taken into account in order to determine the affinity of the cells. This scenario also shows the need for a new dimension in the addressing of cells in a mobile telephone network.

### Scenario 3

The grouping can also take into account the number of cells forming a particular affinity. For example, an indoor mobile telephone coverage within a private residence can be provided by one or two home cells (home access points), i.e. an in-house extension of the mobile telephone network through the use of the home cells.

By contrast, a shopping center would need a larger number of home cells (e.g. 10) to ensure in-house network coverage, i.e. indoor area coverage.

If the mobile telephone terminal is inside the residence, it should only be paged in the 2 home cells of the above example, while the mobile telephone terminal in the shopping center should be paged in all 10 of the cells located there. For optimal and efficient paging performance, it is therefore important in these cases to have different grouping.

### Scenario 4

A further dimension can be to distinguish cells that have a logical affinity but do not form a geographical unit. A fast food chain or a retail chain maintaining shops in several cities are examples of such a case. For this scenario we can assume that each of these shops is served by a home cell. If a subscriber or a mobile telephone terminal is entitled to use the home cells of this chain of shops, it must be assured that this mobile telephone terminal can be given access to each home cell in this chain, i.e. in each home cell of this cell group. This requires addressing that takes account of the affinity of these cells. On the other hand, paging would be very inefficient if the mobile telephone terminal had to be paged in every city and in every shop of this chain. It is therefore important to have several dimensions for addressing. One dimension could be the logical affinity of cells, with the other dimension determining the geographical affinity.

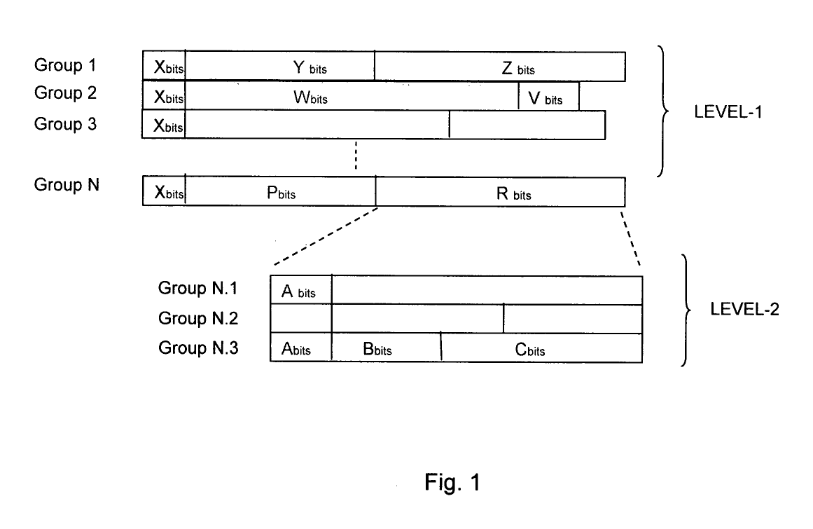

An exemplary embodiment of the invention is illustrated in FIG. 1 and will be explained below with reference to the FIGURE, in which:

FIG. 1 shows a schematic representation of multi-hierarchical addressing of mobile telephone cells.

FIG. 1 shows an example of multi-hierarchical addressing of mobile telephone cells, comprising several groups in each hierarchical level. Each address consists of one or more segments.

For the addressing in the first level, the cells are subdivided into various groups 1, 2, 3, N. In each group, 1, 2, 3, . . . , N, the address consists of several segments X, Y, Z or X, W, V or X, P, R. These segments, X, Y, Z, W, V1 P, R are taken into consideration, either singly or together, for different functions, such as automatic paging of all cells in the group 1, 2, 3 N, which is performed when a connection is to be established with a mobile telephone terminal attached to the cells of the group 1, 2, 3, . . . , N, or for identification of individual cells, or for admission control of mobile telephone terminals. Each group 1, 2, 3, . . . , N can have subgroups N.1, N.2, N.3, and these subgroups N.1, N.2, N.3 can in their turn be taken into account through various functions in the network.

In FIG. 1, the first segment X of the address field identifies the first hierarchical level. The first level can have any desired number of groups, depending on the number of bits in segment X. For example, if segment X consists of 1 bit, there will only be 2 groups in this first level: the first group with 0 as the first bit in the address field, and the second group with 1 as the first bit in the address field. The first segment X of the address field thus identifies the grouping according to the first characteristic, e.g. according to the type of cell. Examples of this are the grouping of “open cells with known positions”, “cells which are positioned together geographically and belong to a CSG consisting of several cells” or “cells belonging to a CSG consisting of several cells, but which can be positioned together geographically or be geographically separate.” CSG is a closed subscriber group. CSG cells are therefore cells within a mobile telephone network which are not open to everyone but can only be utilized by the members of a closed user group.

In group 1, the next segment Y can, for example, specify the grouping of related cells with an affinity according to their position. This means that for group 1, the segment X+Y can be used in a similar way to the location area code in today's UMTS networks.

The number of cells in each geographical group is determined by the number of bits in segment Z. With X+Y+Z bits it is therefore possible to address each single cell in this group 1. This is shown schematically in FIG. 1.

Group 2 can, for example, address the cells which are geographically close to one another and belong to a CSG consisting of several cells. In this case, segment X+W would specify this group 2 and determine the grouping of cells according to CSG affinity and geographical proximity. In group 2, the number of cells in the group is specified by the number of bits in segment V.

Group N can, for example, address the cells which belong to a CSG consisting of several cells, but which can be either geographically close to or remote from one another. In this case, the group N can furthermore be divided into subgroups N.1, N.2, N.3 in such a manner that each subgroup N.1, N.2, N.3 identifies the geographical affinity of the cells in it. Subgrouping into further levels is done in a similar manner to that for level 2. While segment P of a level 1 address shows the CSG affinity of cells, segment B of level 2 shows the geographical proximity of the related cells. The number of subgroups N.1, N.2, N.3 in level 2 is determined by the number of bits in segment A. The number of cells in each subgroup in level 2 is determined by the number of bits in segment C.

The method according to the invention proposes, in particular, multi-hierarchical addressing of mobile telephone cells, with each address consisting of different segments X1 Y, Z, W, V, P, R, A, B1 C. Each segment can in its turn be divided into subgroups.

In accordance with the invention, the addressing of mobile telephone cell is thus performed via a multi-hierarchical addressing system. This addressing system can consist of several is groups in each hierarchy level, and any group in any level can consist of further subgroups. A cell can belong to a group in each of several hierarchy levels and be addressed as a function of the level.

Each address consists of different segments. Each segment can have a different number of bits and each segment in each group can be used for different purposes.

Each segment in an address can be divided into further subgroups in which each address again consists of various segments.

The addressing of cells, for example femtocells/Home NB/Home eNB/CSG cells, in a cellular mobile telephone system is done, in particular, by multi-hierarchical addressing for the purpose of logically connecting instances into groups.

This makes it possible, in particular, to optimize the signaling load (update/paging) in a cellular mobile telephone system by using multi-hierarchical addressing.

It is possible to classify cells into groups with a non-geographical affinity through multi-hierarchical addressing.

Alternatively, or cumulatively, it is possible to classify cells into groups with a partially geographical affinity and some other logical affinity through multi-hierarchical addressing.

1-7. (canceled)

8. A method for operating a cellular mobile telephone network formed by a multiplicity of cells, with several cells at a time being grouped into a location area, by means of which mobile telephone terminals attached to the mobile telephone network can be located and addressed in this location area such that, for the purpose of establishing a call with a mobile telephone terminal, all cells in this location area page the mobile telephone terminal, wherein several groups of location areas are created, with each cell being assigned to one or more groups and a cell being assignable to different groups, and addressing of the cell being performed according to its affinity to a specific group, whereas a group comprises a plurality of subgroups.

9. The method according to claim 8, wherein the groups are formed according to definable criteria, in particular according to which cells form a geographically connected or geographically delimited area or a group of cells for a closed subscriber group or a logically connected group of cells.

10. The method according to claim 8, wherein the location areas of different groups overlap spatially, the groups being ordered hierarchically and addressing taking place according to the hierarchical level.

11. The method according to claim 8, wherein several hierarchical levels of groups are established, with each hierarchical level comprising a plurality of groups.

12. The method according to claim 8, wherein each cell has an address for each affinity to a group, the address being formed of several segments which identify the affinity of the cell to a specific hierarchical level or to a specific group or to a specific location area.

13. The computer program product comprising a computer program capable of running on a data processing system and having program instructions for performing the steps of the method according to claim 8 when the computer program is executed on a data processing system.
